(19) United States
(12) Patent Application Publication
(10) Pub. No.: US 2005/0194555 A1
(43) Pub. Date: Sep. 8, 2005

(54) Flared Tube and Valve Connection

(75) Inventor: Bernard E. Hall, London (CA)

Correspondence Address: CHECKFLUID INC., 4500 BLAKLE ROAD, UNIT #102, LONDON, N6L 1G5, CA

(73) Assignee: CHECKFLUID INC., London (CA)

(21) Appl. No.: 10/906,770

(22) Filed: Mar. 5, 2005

Related U.S. Application Data
(60) Provisional application No. 60/521,186, filed on Mar. 5, 2004.

(51) Int. Cl. F16K 51/00

(52) U.S. Cl. 251/146

(57) ABSTRACT

A sealed joint structure for connecting a tube to a male threaded valve or fitting which allows fluid to be sampled or sounds to be amplified more precisely from a location within a fluid vessel, closer to the moving components. The connection includes a valve, a flared tube, a radial seal and a backup spacer. The present invention relates to a novel fluid transfer connection to draw or fill fluid residing in a remotely accessible reservoir from a tube mounted in a male threaded fitting. This fitting is typically mounted to a port on the reservoir. Typically fluid is drawn to analyze the physical and chemical properties of the fluid especially in oil lubricated power transmission devices such as gearboxes and pumps. It is highly desirable to draw, in a timely fashion, a representative fluid sample from the same location in the reservoir, from time to time, in order to accurately trend changes in fluid characteristics that relate to the integrity of the fluid and the lubricated device.

### BACKGROUND OF INVENTION

Current methods employed to obtain representative fluid samples via tubes include threaded, brazed, welded, ferrule or clip style connections. A compact, tightly sealed connection of valve and tube is required to sample fluid using vacuum pressure in confined spaces.

A threaded tube connection typically seals metal to metal and is often either too large in diameter to insert into a port on a gearbox or the threaded nut protrudes too far beyond the fitting to mount into another threaded adapter fitting. Also when a threaded tube connection can be mounted, the tube must be reduced in size and often is not able to adequately transfer viscous fluid in a timely manner.

A brazed or welded connection creates a high heat condition in the joining process which deteriorates most rubber seals including nitrile (NBR) either when installed at the joint or when installed on the internal valve.

Coined collet or compression sleeve tube connections also commonly rely on metal to metal seals on the tube to achieve sealing which is generally unreliable for vacuum sampling.

A clip style connection requires a clip groove on the fitting, which would interfere with the external thread used to secure the tube and fitting connection in a port.

The present invention allows a mechanical connection method that does not interfere with the existing male thread or port thread, does not interfere with the integrity of internal valve seal or sealed sensor components and provides a full flow fluid transfer.

The present invention relies on an elastomeric seal that is precisely compressed with a backup spacer to seal on both the tube and the valve to achieve more reliable sealing for fluid transfer using vacuum suction.

Also the seal on the tube dampens extraneous sounds from the casing and amplifies the sounds within the vessel when used for ultrasonic testing.

### BRIEF DESCRIPTION OF DRAWINGS

FIG. 1 is an exploded cutaway view of the assembly in a valve.

FIG. 2 is a detailed cutaway view of the assembly in a valve.

FIG. 3 is a principal view of the assembly showing the retention of the tube in the valve

FIG. 4 is an exploded cutaway view of the assembly in a fitting

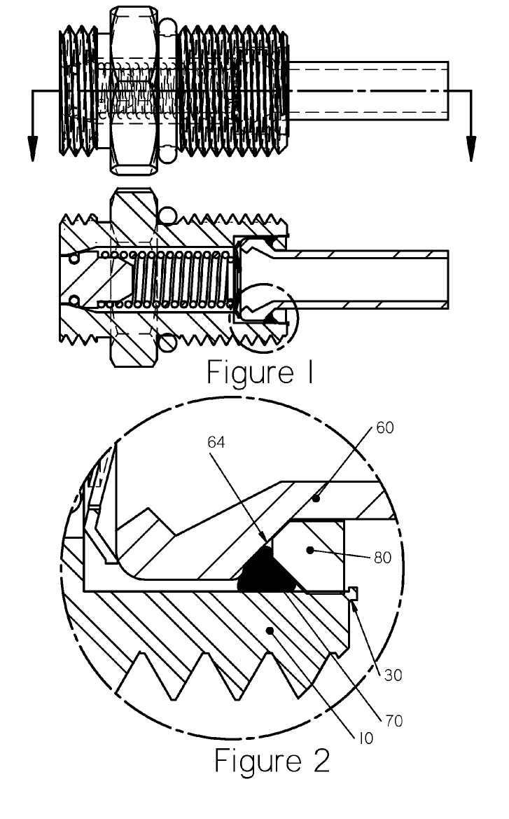

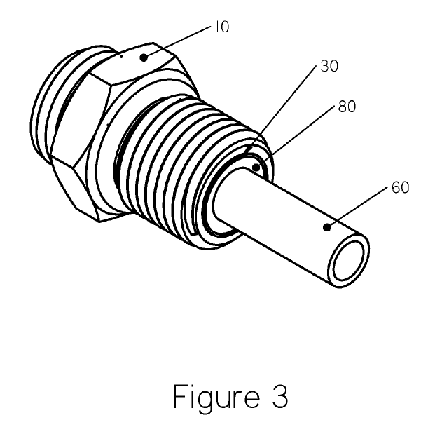

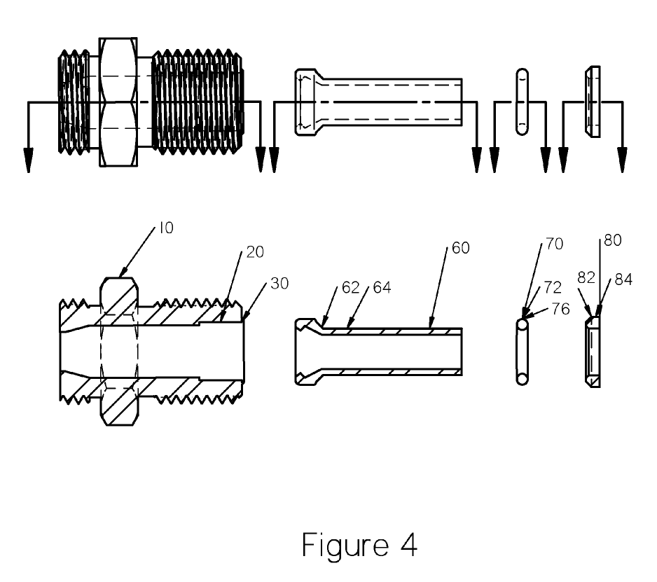

### DETAILED DESCRIPTION

The valve 10 includes a recessed cylindrical cavity 20, sized for receipt of a flared tube 60, radial seal 70, backup spacer 80 and a thin wall extension 30 which can be formed to retain the flared tube, radial seal, backup spacer with the valve. The radial seal 70 is positioned behind the flare of the tube 62, typically a double flared tube according to SAE standard J533, to seal both the outside diameter of the tube 64 with the inside diameter of the seal 76 and also the inside recess of the valve 20 with the outside diameter of the seal 72. The backup spacer 80 is fitted onto the tube 60 and located behind the seal 70. The outside diameter of the spacer 82 is angled to retain the radial seal 70 in a sealing position on the flare 62 and sized on the outside diameter 84 to be press fitted into the cylindrical cavity of the valve 20. The thin wall extension 30 is then coined over the spacer 80 to further retain the joint components.

1. A sealed joint structure comprising:
a valve with a thin wall extension which forms an angled structure to retain
a flared tube with the flare extending radially outward and forward from the tube,
an elastomeric seal, typically an o-ring which seals both the outside wall of the tube and the inside wall of the valve and a spacer, angularly shaped at one side of the front surface which contacts the flared portion of the tube, angularly shaped at the opposite side of the front surface which contacts and compresses the seal and shaped flat at the rear surface facing the tube and thin wall extension.

2. A sealed joint structure according to claim 1, wherein the valve is an unvalved fitting with a thin wall extension.

3. A sealed joint structure according to claim 1, wherein the valve is a port with a thin wall extension.

4. A sealed joint structure according to claim 1, wherein the flare on the tube is a single flare.

5. A sealed joint structure according to claim 1, wherein the flare on the tube is angularly shaped.

6. A sealed joint structure according to claim 1, wherein the thin wall extension is a flat face surface of a threaded fitting.

7. A sealed joint structure according to claim 1, wherein the backup spacer is the front face of a threaded fitting, angularly shaped at one side of the front surface which contacts the flared portion of the tube and angularly shaped at the opposite side of the front surface which contacts and compresses the seal into the inside recess.
